(19) United States
(12) Patent Application Publication
(10) Pub. No.: US 2023/0335804 A1
(43) Pub. Date: Oct. 19, 2023

(54) SECONDARY BATTERY, ELECTRONIC EQUIPMENT, AND ELECTRIC TOOL

(71) Applicant: MURATA MANUFACTURING CO., LTD., Kyoto (JP)

(72) Inventor: Akira SHINKAWA, Kyoto (JP)

(21) Appl. No.: 18/211,946

(22) Filed: Jun. 20, 2023

Related U.S. Application Data
(63) Continuation of application No. PCT/JP2022/001898, filed on Jan. 20, 2022.

(30) Foreign Application Priority Data
Jan. 28, 2021 (JP) 2021-011605

(51) Int. Cl. H01M 10/0587; H01M 50/119; H01M 10/0525; H01M 50/531

(52) U.S. Cl. CPC H01M 10/0587; H01M 50/119; H01M 10/0525; H01M 50/531

(57) ABSTRACT

A secondary battery is provided and includes an electrode wound body, a positive electrode current collector, a negative electrode current collector, and a battery can. The electrode wound body includes a positive electrode having a band shape and a negative electrode having a band shape. The positive electrode and the negative electrode are stacked with a separator interposed therebetween. The battery can contains the electrode wound body, the positive electrode current collector, and the negative electrode current collector. The positive electrode includes, on a positive electrode foil having a band shape, a positive electrode active material covered part covered with a positive electrode active material layer, and a positive electrode active material uncovered part. The negative electrode includes, on a negative electrode foil having a band shape, a negative electrode active material covered part covered with a negative electrode active material layer, a negative electrode active material uncovered part extending at least in a longitudinal direction of the negative electrode foil, and an insulating layer provided between the negative electrode active material covered part and the negative electrode active material uncovered part. The positive electrode active material uncovered part is coupled to the positive electrode current collector at one of end parts of the electrode wound body. The negative electrode active material uncovered part is coupled to the negative electrode current collector at another of the end parts of the electrode wound body. The insulating layer includes a metal or metal compound having an X-ray shielding effect higher than a predetermined X-ray shielding effect.

### CROSS REFERENCE TO RELATED APPLICATIONS

The present application is a continuation of PCT patent application no. PCT/JP2022/001898, filed on Jan. 20, 2022, which claims priority to Japanese patent application no. JP2021-011605, filed on Jan. 28, 2021, the entire contents of which are incorporated herein by reference.

### BACKGROUND

The present application relates to a secondary battery, electronic equipment, and an electric tool.

Development of lithium ion batteries has expanded to applications that require high output power, including electric tools and vehicles. One of methods to achieve high output power is high-rate discharging in which a relatively large current is fed from a battery. Because the high-rate discharging involves feeding of a large current, it is desirable to reduce an internal resistance of the battery.

For example, a cylindrical battery is described having a so-called tabless structure without a tab for leading out electric power of the battery to the outside. An inspection device is described for inspecting a wound object to be inspected for any winding misalignment state by means of image processing.

### SUMMARY

The present application relates to a secondary battery, electronic equipment, and an electric tool.

Typically, in a process of fabricating a lithium ion battery, an inspection process is performed to inspect the lithium ion battery for any winding misalignment. For example, in a case of a lithium ion battery having a tabless structure, the inspection process is performed to detect, as the winding misalignment, a state where a positive electrode active material covered part covered with a positive electrode active material exceeds a range of a negative electrode active material covered part covered with a negative electrode active material, in other words, a state where the positive electrode active material covered part and the negative electrode active material covered part fail to be opposed to each other. With a technique described in each of the cylindrical battery and the inspection device referenced in the Background section, it is difficult to detect an end of the negative electrode active material covered part in performing the above-described inspection, which makes it difficult to perform the inspection for winding misalignment.

The present disclosure relates to providing a secondary battery having a structure allowing for performing inspection for winding misalignment, and to providing electronic equipment and an electric tool that each include the secondary battery according to an embodiment.

In an embodiment, a secondary battery includes an electrode wound body, a positive electrode current collector, a negative electrode current collector, and a battery can. The electrode wound body includes a positive electrode having a band shape and a negative electrode having a band shape. The positive electrode and the negative electrode are stacked with a separator interposed therebetween. The battery can contains the electrode wound body, the positive electrode current collector, and the negative electrode current collector.

The positive electrode includes, on a positive electrode foil having a band shape, a positive electrode active material covered part covered with a positive electrode active material layer, and a positive electrode active material uncovered part.

The negative electrode includes, on a negative electrode foil having a band shape, a negative electrode active material covered part covered with a negative electrode active material layer, a negative electrode active material uncovered part extending at least in a longitudinal direction of the negative electrode foil, and an insulating layer provided between the negative electrode active material covered part and the negative electrode active material uncovered part.

The positive electrode active material uncovered part is coupled to the positive electrode current collector at one of end parts of the electrode wound body.

The negative electrode active material uncovered part is coupled to the negative electrode current collector at another of the end parts of the electrode wound body.

The insulating layer includes a metal or metal compound having an X-ray shielding effect higher than a predetermined X-ray shielding effect.

In an embodiment, the present technology makes it possible to provide a secondary battery having a structure allowing for performing inspection for winding misalignment. It should be understood that the contents of the present disclosure are not to be construed as being limited by the effects exemplified herein.

### BRIEF DESCRIPTION OF THE FIGURES

FIG. 1 is a sectional view of a lithium ion battery according to an embodiment.

FIG. 2 includes views A and B which are diagrams for describing a positive electrode according to an embodiment.

FIG. 3 includes views A and B which are diagrams for describing a negative electrode according to an embodiment.

FIG. 4 is a diagram illustrating the positive electrode, the negative electrode, and a separator before being wound.

FIG. 5 includes view A which is a plan view of a positive electrode current collector according to an embodiment, and view B which is a plan view of a negative electrode current collector according to an embodiment.

FIG. 6 includes views A to F which are diagrams describing a process of assembling the lithium ion battery according to an embodiment.

FIG. 7 is a diagram for describing workings of an insulating layer according to an embodiment and effects achievable by providing the insulating layer.

FIG. 8 is a diagram for describing Comparative example 1.

FIG. 9 is a diagram for describing Comparative example 1.

FIG. 10 is a coupling diagram for use to describe a battery pack as an application example according to an embodiment.

FIG. 11 is a coupling diagram for use to describe an electric tool as an application example.

FIG. 12 is a coupling diagram for use to describe an electric vehicle as an application example.

### DETAILED DESCRIPTION

The present disclosure is described below in further detail including with reference to the drawings according to an embodiment. One or more embodiments described herein are examples of the present disclosure, and the contents of the present disclosure are not limited thereto. It is to be noted that in order to facilitate understanding of description, one or more features including one or more components as illustrated in any of the drawings may be enlarged or reduced, or illustration of some portions may be simplified.

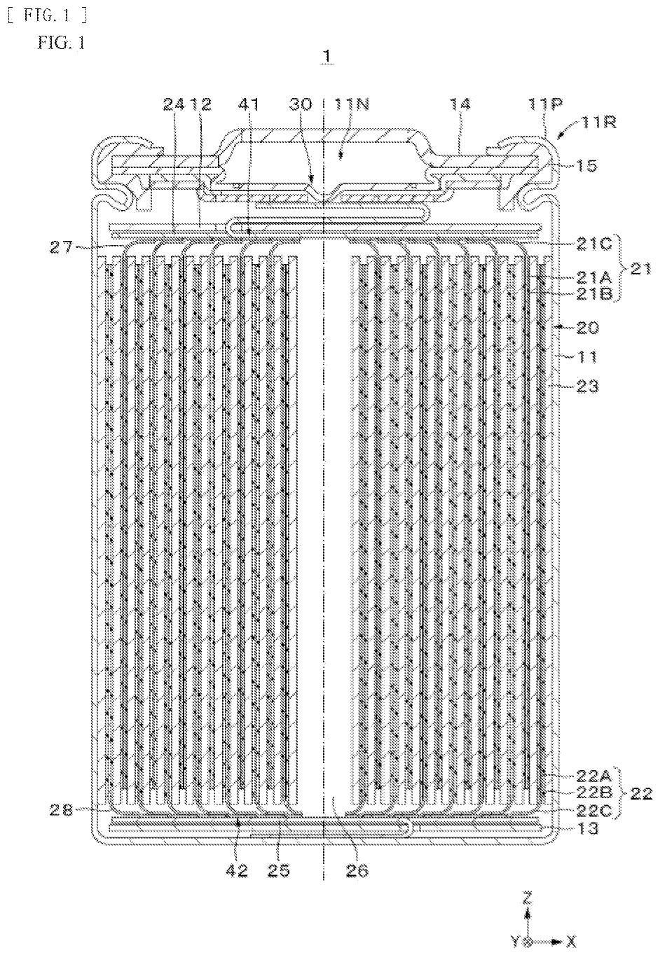

In an embodiment, a lithium ion battery having a cylindrical shape will be described as an example of a secondary battery. An overall configuration of the lithium ion battery according to the present embodiment, i.e., a lithium ion battery 1, will be described with reference to FIGS. 1 to 5. FIG. 1 is a schematic sectional view of the lithium ion battery 1. As illustrated in FIG. 1, the lithium ion battery 1 has a cylindrical shape and includes an electrode wound body 20 contained inside a battery can 11, for example.

In a schematic configuration, the lithium ion battery 1 includes the battery can 11 having a cylindrical shape, and also includes, inside the battery can 11, a pair of insulators 12 and 13 and the electrode wound body 20. Note that the lithium ion battery 1 may further include, for example, one or more of devices and members including, without limitation, a thermosensitive resistive device or a PTC device and a reinforcing member, inside the battery can 11.

The battery can 11 is a member that contains mainly the electrode wound body 20. The battery can 11 is, for example, a cylindrical container with one end face open and another end face closed. That is, the battery can 11 has one open end face (an open end face 11N). The battery can 11 includes, for example, one or more of metal materials including, without limitation, iron, aluminum, and alloys thereof. The battery can 11 may have a surface plated with one or more of metal materials including, without limitation, nickel, for example.

The insulators 12 and 13 are disk-shaped plates each having a surface that is substantially perpendicular to a central axis of the electrode wound body 20. The central axis passes through substantially a center of each of end faces of the electrode wound body 20 and is in a direction parallel to a Z-axis in FIG. 1. The insulators 12 and 13 are so disposed as to allow the electrode wound body 20 to be interposed therebetween, for example.

A battery cover 14 and a safety valve mechanism 30 are crimped to the open end face 11N of the battery can 11 via a gasket 15 to thereby provide a crimped structure 11R (a crimp structure). The battery can 11 is thus sealed, with the electrode wound body 20 and other components being contained inside the battery can 11.

The battery cover 14 is a member that closes the open end face 11N of the battery can 11 mainly in the state where the electrode wound body 20 and the other components are contained inside the battery can 11. The battery cover 14 includes, for example, a material similar to the material included in the battery can 11. A middle region of the battery cover 14 protrudes in a +Z direction, for example. A region other than the middle region, that is, a peripheral region, of the battery cover 14 is thus in contact with the safety valve mechanism 30, for example.

The gasket 15 is a member that is mainly interposed between the battery can 11 (a bent part 11P) and the battery cover 14 to thereby seal a gap between the bent part 11P and the battery cover 14. Note that the gasket 15 may have a surface coated with a material such as asphalt, for example.

The gasket 15 includes one or more of insulating materials, for example. The insulating material is not particularly limited in kind. For example, a polymer material such as polybutylene terephthalate (PBT) or polypropylene (PP) may be used as the insulating material. In particular, the insulating material is preferably polybutylene terephthalate. A reason for this is that such a material is able to sufficiently seal the gap between the bent part 11P and the battery cover 14 while electrically separating the battery can 11 and the battery cover 14 from each other.

The safety valve mechanism 30 cancels the sealed state of the battery can 11 and thereby releases a pressure inside the battery can 11, i.e., an internal pressure of the battery can 11 on an as-needed basis, mainly upon an increase in the internal pressure. Examples of a cause of the increase in the internal pressure of the battery can 11 include a gas generated due to a decomposition reaction of an electrolytic solution during charging and discharging.

In the lithium ion battery 1 having a cylindrical shape, a positive electrode 21 having a band shape and a negative electrode 22 having a band shape, which are stacked with a separator 23 interposed therebetween and are wound in a spiral shape, are contained in the battery can 11, being impregnated with the electrolytic solution. The positive electrode 21 includes a positive electrode foil 21A with a positive electrode active material layer 21B provided on one of or each of both surfaces of the positive electrode foil 21A. A material of the positive electrode foil 21A is a metal foil including, for example, aluminum or an aluminum alloy. The negative electrode 22 includes a negative electrode foil 22A with a negative electrode active material layer 22B provided on one of or each of both surfaces of the negative electrode foil 22A. A material of the negative electrode foil 22A is a metal foil including, for example, nickel, a nickel alloy, copper, or a copper alloy. The separator 23 is a porous insulating film. The separator 23 electrically insulates the positive electrode 21 and the negative electrode 22 from each other, and allows for movement of substances including, without limitation, ions and the electrolytic solution.

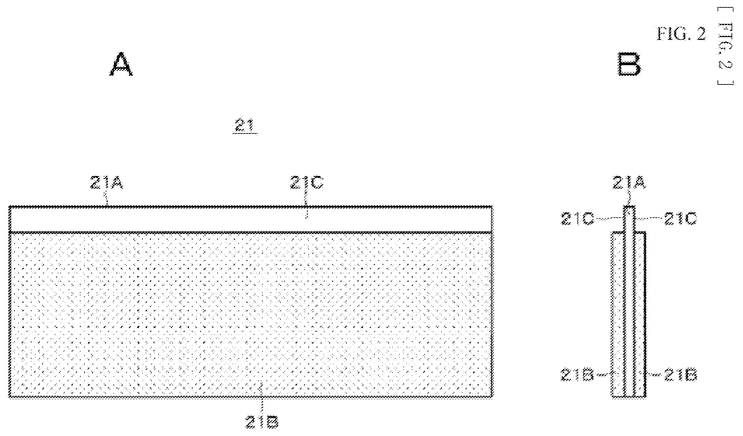

FIG. 2, view A is a front view of the positive electrode 21 before being wound. FIG. 2B is a side view of the positive electrode 21 of FIG. 2, view A. The positive electrode 21 includes, at each of one major surface and another major surface of the positive electrode foil 21A, a part (a part shaded with dots) covered with the positive electrode active material layer 21B, and a positive electrode active material uncovered part 21C which is a part not covered with the positive electrode active material layer 21B. Note that in the following description, the part covered with the positive electrode active material layer 21B will be referred to as a positive electrode active material covered part 21B as appropriate. The positive electrode 21 may have a configuration in which the positive electrode active material covered part 21B is provided at one of the major surfaces of the positive electrode foil 21A.

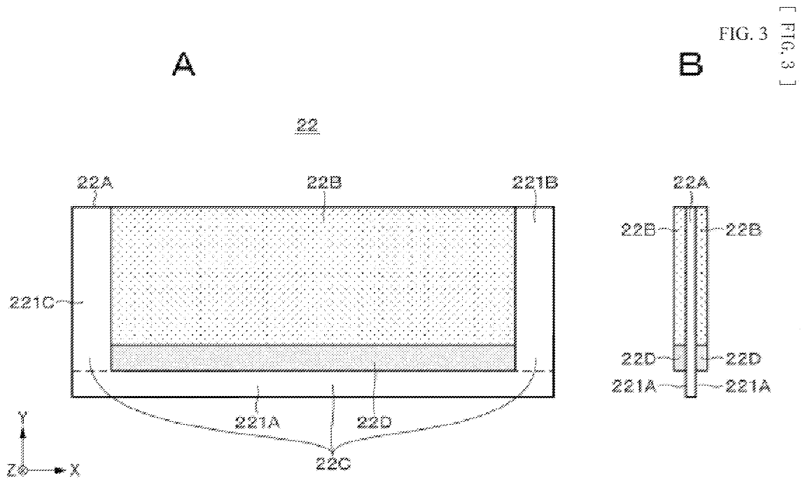

FIG. 3, view A is a front view of the negative electrode 22 before being wound. FIG. 3B is a side view of the negative electrode 22 of FIG. 3, view A. The negative electrode 22 includes, at each of one major surface and another major surface of the negative electrode foil 22A, a part (a part shaded with dots) covered with the negative electrode active material layer 22B, and a negative electrode active material uncovered part 22C which is a part not covered with the negative electrode active material layer 22B. Note that in the following description, the part covered with the negative electrode active material layer 22B will be referred to as a negative electrode active material covered part 22B as appropriate. The negative electrode 22 may have a configuration in which the negative electrode active material covered part 22B is provided at one of the major surfaces of the negative electrode foil 22A.

As illustrated in FIG. 3, view A, the negative electrode active material uncovered part 22C includes, for example, a first negative electrode active material uncovered part 221A, a second negative electrode active material uncovered part 221B, and a third negative electrode active material uncovered part 221C. The first negative electrode active material uncovered part 221A extends in a longitudinal direction of the negative electrode 22, i.e., in an X-axis direction in FIG. 3. The second negative electrode active material uncovered part 221B is provided on a beginning side of winding of the negative electrode 22 and extends in a transverse direction of the negative electrode 22, i.e., in a Y-axis direction in FIG. 3, which will also be referred to as a width direction as appropriate. The third negative electrode active material uncovered part 221C is provided on an end side of the winding of the negative electrode 22 and extends in the transverse direction of the negative electrode 22, i.e., in the Y-axis direction in FIG. 3. Note that in FIG. 3, view A, a boundary between the first negative electrode active material uncovered part 221A and the second negative electrode active material uncovered part 221B, and a boundary between the first negative electrode active material uncovered part 221A and the third negative electrode active material uncovered part 221C are each represented by a dashed line.

The negative electrode 22 further includes an insulating layer 22D (a gray part in FIG. 3). The insulating layer 22D is provided between the negative electrode active material covered part 22B and the first negative electrode active material uncovered part 221A. Details of the insulating layer 22D will be described later.

In the electrode wound body 20 of the lithium ion battery 1 having the cylindrical shape according to the present embodiment, the positive electrode 21 and the negative electrode 22 are laid over each other and wound, with the separator 23 interposed therebetween, in such a manner that the positive electrode active material uncovered part 21C and the first negative electrode active material uncovered part 221A face toward opposite directions.

The electrode wound body 20 has a through hole 26 at a center thereof. Specifically, the through hole 26 is a hole part that develops at substantially a center of a stack in which the positive electrode 21, the negative electrode 22, and the separator 23 are stacked. The through hole 26 is used as a hole into which a rod-shaped welding tool, which will hereinafter be referred to as a welding rod, as appropriate, is to be inserted in a process of assembling the lithium ion battery 1.

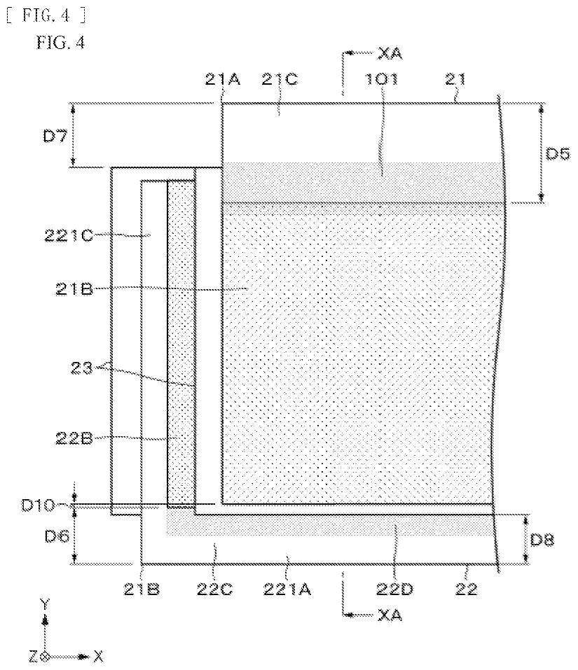

Details of the electrode wound body 20 will be described. FIG. 4 illustrates an example of a pre-winding structure in which the positive electrode 21, the negative electrode 22, and the separator 23 are stacked. The positive electrode 21 further includes an insulating layer 101 (a gray region part in FIG. 4) covering a boundary between the positive electrode active material covered part 21B (a part lightly shaded with dots in FIG. 4) and the positive electrode active material uncovered part 21C. The insulating layer 101 has a length in the width direction of about 3 mm, for example. All of a region of the positive electrode active material uncovered part 21C opposed to the negative electrode active material covered part 22B with the separator 23 interposed therebetween is covered with the insulating layer 101. The insulating layer 101 has an effect of reliably preventing an internal short circuit of the lithium ion battery 1 when foreign matter enters between the negative electrode active material covered part 22B and the positive electrode active material uncovered part 21C. In addition, the insulating layer 101 has an effect of, in a case where the lithium ion battery 1 undergoes an impact, absorbing the impact and thereby reliably preventing the positive electrode active material uncovered part 21C from bending and short-circuiting with the negative electrode 22.

Here, as illustrated in FIG. 4, a length of the positive electrode active material uncovered part 21C in the width direction is denoted as D5, and a length of the first negative electrode active material uncovered part 221A in the width direction is denoted as D6. In an embodiment, it is preferable that D5>D6. For example, D5=7 (mm), and D6=4 (mm). Where a length of a portion of the positive electrode active material uncovered part 21C protruding from one end in the width direction of the separator 23 is denoted as D7 and a length of a portion of each of the insulating layer 22D and the first negative electrode active material uncovered part 221A protruding from another end in the width direction of the separator 23 is denoted as D8, in an embodiment, it is preferable that D7>D8. For example, D7=4.5 (mm), and D8=3 (mm).

The positive electrode foil 21A and the positive electrode active material uncovered part 21C include aluminum, for example. The negative electrode foil 22A and the negative electrode active material uncovered part 22C include copper, for example. Thus, the positive electrode active material uncovered part 21C is typically softer, that is, lower in Young's modulus, than the negative electrode active material uncovered part 22C. Accordingly, in an embodiment, it is more preferable that D5>D6 and D7>D8. In such a case, when portions of the positive electrode active material uncovered part 21C and portions of the negative electrode active material uncovered part 22C (in this example, portions of the first negative electrode active material uncovered part 221A) are simultaneously bent with equal pressures from both electrode sides, respective heights of the bent portions as measured from respective ends of the separator 23 may be substantially the same between the positive electrode 21 and the negative electrode 22. In this situation, the portions of the positive electrode active material uncovered part 21C appropriately overlap with each other when bent, which makes it possible to easily couple the positive electrode active material uncovered part 21C and a positive electrode current collector 24 to each other by laser welding in a process of fabricating the lithium ion battery 1. Further, the portions of the first negative electrode active material uncovered part 221A appropriately overlap with each other when bent, which makes it possible to easily couple the first negative electrode active material uncovered part 221A and a negative electrode current collector 25 to each other by laser welding in the process of fabricating the lithium ion battery 1. Details of the process of fabricating the lithium ion battery 1 will be described later.

In a typical lithium ion battery, for example, a lead for current extraction is welded at one location on each of the positive electrode and the negative electrode. However, such a configuration is not suitable for high-rate discharging because a high internal resistance of the battery results to cause the lithium ion battery to generate heat and become hot during discharging. To address this, in the lithium ion battery 1 according to the present embodiment, the positive electrode current collector 24 is disposed on one end face, i.e., an end face 41, of the electrode wound body 20, and the negative electrode current collector 25 is disposed on another end face, i.e., an end face 42, of the electrode wound body 20. In addition, the positive electrode current collector 24 and the positive electrode active material uncovered part 21C located at the end face 41 are welded to each other at multiple points; and the negative electrode current collector 25 and the first negative electrode active material uncovered part 221A located at the end face 42 are welded to each other at multiple points. The internal resistance of the lithium ion battery 1 is thereby kept low to allow for high-rate discharging.

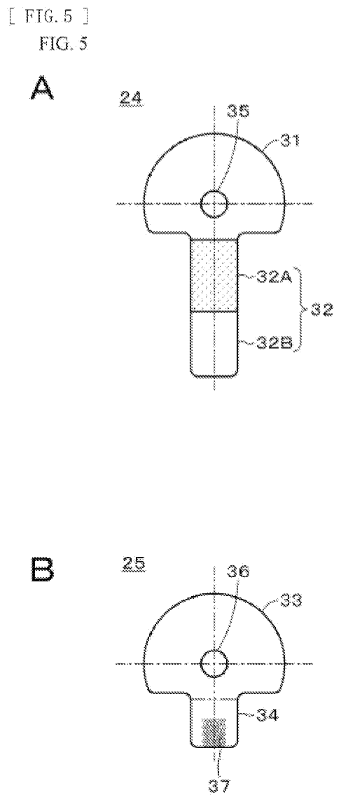

FIG. 5, views A and B illustrate respective examples of the current collectors. FIG. 5, view A illustrates the positive electrode current collector 24. FIG. 5, view B illustrates the negative electrode current collector 25. The positive electrode current collector 24 and the negative electrode current collector 25 are contained in the battery can 11 (see FIG. 1). A material of the positive electrode current collector 24 is a metal plate including, for example, a simple substance or a composite material of aluminum or an aluminum alloy. A material of the negative electrode current collector 25 is a metal plate including, for example, a simple substance or a composite material of nickel, a nickel alloy, copper, or a copper alloy. As illustrated in FIG. 5, view A, the positive electrode current collector 24 has a shape in which a band-shaped part 32 having a rectangular shape is attached to a fan-shaped part 31 having a flat fan shape. The fan-shaped part 31 has a hole 35 at a position near a middle thereof. The position of the hole 35 corresponds to a position of the through hole 26.

A part shaded with dots in FIG. 5, view A represents an insulating part 32A in which an insulating tape or an insulating material is attached or applied to the band-shaped part 32. A part below the dot-shaded part in FIG. 5, view A represents a coupling part 32B to be coupled to a sealing plate that also serves as an external terminal. Note that in a case of a battery structure having no metallic center pin (not illustrated) in the through hole 26, the insulating part 32A may be omitted because there is a low possibility of contact of the band-shaped part 32 with a region of a negative electrode potential. In such a case, it is possible to increase charge and discharge capacities by increasing a width of each of the positive electrode 21 and the negative electrode 22 by an amount corresponding to a thickness of the insulating part 32A.

The negative electrode current collector 25 is similar to the positive electrode current collector 24 in shape, but has a band-shaped part of a different shape. The band-shaped part 34 of the negative electrode current collector of FIG. 5B is shorter than the band-shaped part 32 of the positive electrode current collector 24 and includes no portion corresponding to the insulating part 32A. The band-shaped part 34 is provided with circular projections 37 depicted as multiple circles. Upon resistance welding, current is concentrated on the projections 37, causing the projections 37 to melt to thereby cause the band-shaped part 34 to be welded to a bottom of the battery can 11. As with the positive electrode current collector 24, the negative electrode current collector 25 has a hole 36 at a position near a middle of a fan-shaped part 33. The position of the hole 36 corresponds to the position of the through hole 26. The fan-shaped part 31 of the positive electrode current collector 24 and the fan-shaped part 33 of the negative electrode current collector 25, which are each in the shape of a fan, cover respective portions of the end faces 41 and 42. By not covering all of the respective end faces 41 and 42, it is possible to allow the electrolytic solution to smoothly permeate the electrode wound body 20 in assembling the lithium ion battery 1, and it is also possible to facilitate releasing of a gas, which is generated when the lithium ion battery 1 comes into an abnormally hot state or an overcharged state, to the outside of the lithium ion battery 1.

The positive electrode active material layer 21B includes at least a positive electrode material (a positive electrode active material) into which lithium is insertable and from which lithium is extractable, and may further include, for example, a positive electrode binder and a positive electrode conductor. The positive electrode material is preferably a lithium-containing composite oxide or a lithium-containing phosphoric acid compound. The lithium-containing composite oxide has a layered rock-salt crystal structure or a spinel crystal structure, for example. The lithium-containing phosphoric acid compound has an olivine crystal structure, for example.

The positive electrode binder includes a synthetic rubber or a polymer compound. Examples of the synthetic rubber include a styrene-butadiene-based rubber, a fluorine-based rubber, and ethylene propylene diene. Examples of the polymer compound include polyvinylidene difluoride (PVDF) and polyimide.

The positive electrode conductor is a carbon material such as graphite, carbon black, acetylene black, or Ketjen black. Note that the positive electrode conductor may be a metal material or an electrically conductive polymer.

The negative electrode foil 22A configuring the negative electrode 22 is preferably roughened at its surface to achieve improved adherence to the negative electrode active material layer 22B. The negative electrode active material layer 22B includes at least a negative electrode material (a negative electrode active material) into which lithium is insertable and from which lithium is extractable, and may further include, for example, a negative electrode binder and a negative electrode conductor.

The negative electrode material includes a carbon material, for example. The carbon material is graphitizable carbon, non-graphitizable carbon, graphite, low-crystalline carbon, or amorphous carbon. The carbon material has a fibrous shape, a spherical shape, a granular shape, or a flaky shape.

Further, the negative electrode material includes a metal-based material, for example. Examples of the metal-based material include Li (lithium), Si (silicon), Sn (tin), Al (aluminum), Zr (zinc), and Ti (titanium). A metallic element forms a compound, a mixture, or an alloy with another element, and examples thereof include silicon oxide (SiOₓ (0<x≤2)), silicon carbide (SiC), an alloy of carbon and silicon, and lithium titanium oxide (LTO).

The separator 23 is a porous film including a resin, and may be a stacked film including two or more kinds of porous films. Examples of the resin include polypropylene and polyethylene. With the porous film as a base layer, the separator 23 may include a resin layer provided on one of or each of both surfaces of the base layer. A reason for this is that this improves adherence of the separator 23 to each of the positive electrode 21 and the negative electrode 22 and thus suppresses distortion of the electrode wound body 20.

The resin layer includes a resin such as PVDF. In a case of forming the resin layer, a solution including an organic solvent and the resin dissolved therein is applied on the base layer, following which the base layer is dried. Note that the base layer may be immersed in the solution and thereafter the base layer may be dried. From the viewpoint of improving heat resistance and battery safety, the resin layer preferably includes inorganic particles or organic particles. Examples of the kind of the inorganic particles include aluminum oxide, aluminum nitride, aluminum hydroxide, magnesium hydroxide, boehmite, talc, silica, and mica. Alternatively, a surface layer including inorganic particles as a main component and formed by a method such as a sputtering method or an atomic layer deposition (ALD) method may be used instead of the resin layer.

The electrolytic solution includes a solvent and an electrolyte salt, and may further include other materials such as additives on an as-needed basis. The solvent is a nonaqueous solvent such as an organic solvent, or water. The electrolytic solution including a nonaqueous solvent is called a nonaqueous electrolytic solution. Examples of the nonaqueous solvent include a cyclic carbonic acid ester, a chain carbonic acid ester, a lactone, a chain carboxylic acid ester, and a nitrile (mononitrile).

Although a typical example of the electrolyte salt is a lithium salt, the electrolyte salt may include any salt other than the lithium salt. Examples of the lithium salt include lithium hexafluorophosphate (LiPF₆), lithium tetrafluoroborate (LiBF₄), lithium perchlorate (LiClO₄), lithium methanesulfonate (LiCH₃SO₃), lithium trifluoromethanesulfonate (LiCF₃SO₃), and dilithium hexafluorosilicate (Li₂SF₆). These salts may also be used in mixture with each other. From the viewpoint of improving a battery characteristic, it is preferable to use a mixture of LiPF₆ and LiBF₄, in particular. Although not particularly limited, a content of the electrolyte salt is preferably in a range from 0.3 mol/kg to 3 mol/kg both inclusive with respect to the solvent.

### [Details of Insulating Layer]

Next, the foregoing insulating layer 22D will be described in detail. The insulating layer 22D includes, for example, a resin such as PVDF. The insulating layer 22D may further include inorganic particles or organic particles. Examples of the inorganic particles include particles of one or more of materials including, without limitation, aluminum oxide, aluminum nitride, aluminum hydroxide, magnesium hydroxide, boehmite, talc, silica, and mica.

In the present embodiment, as illustrated in FIG. 3B, the negative electrode active material covered part 22B and the insulating layer 22D are provided on each of both surfaces of the negative electrode foil 22A. The insulating layer 22D extends between the first negative electrode active material uncovered part 221A and the negative electrode active material covered part 22B that each extend in the longitudinal direction of the negative electrode 22, i.e., in the X-axis direction. To be more specific, the insulating layer 22D is located along a boundary between the first negative electrode active material uncovered part 221A and the negative electrode active material covered part 22B that each extend in the longitudinal direction of the negative electrode 22, i.e., in the X-axis direction. The insulating layer 22D has a thickness smaller than or equal to a thickness of the negative electrode active material covered part 22B. Note that the negative electrode 22 may have a configuration in which the negative electrode active material covered part 22B and the insulating layer 22D are provided on one of the major surfaces of the negative electrode foil 22A. The negative electrode 22 may have a configuration in which the negative electrode active material covered part 22B is provided on each of both major surfaces of the negative electrode foil 22A and the insulating layer 22D is provided only on one of the major surfaces of the negative electrode foil 22A.

Furthermore, the insulating layer 22D includes a metal or metal compound having an X-ray shielding effect higher than a predetermined X-ray shielding effect. Specifically, the insulating layer 22D includes a metal having an X-ray shielding effect higher than that of the metal included in the negative electrode foil 22A (the metal mainly included in the negative electrode foil 22A), or a metal compound including a metal having an X-ray shielding effect higher than that of the metal included in the negative electrode foil 22A (the metal mainly included in the negative electrode foil 22A). More specifically, the insulating layer 22D includes particles of the above-described metal, or particles of the above-described metal compound.

The metal having an X-ray shielding effect higher than that of the metal included in the negative electrode foil 22A includes one or more selected from the group consisting of tungsten (W), iridium (Ir), platinum (Pt), and gold (Au), for example. The metal compound including a metal having an X-ray shielding effect higher than that of the metal included in the negative electrode foil 22A includes one or more selected from the group consisting of a metal oxide, a metal sulfate compound, and a metal carbonate compound. The metal oxide includes one or more selected from the group consisting of yttrium oxide, hafnium oxide, tantalum pentoxide, and tungsten oxide, for example. The metal sulfate compound includes one or more selected from the group consisting of barium sulfate and strontium sulfate, for example. The metal carbonate compound includes strontium carbonate, for example.

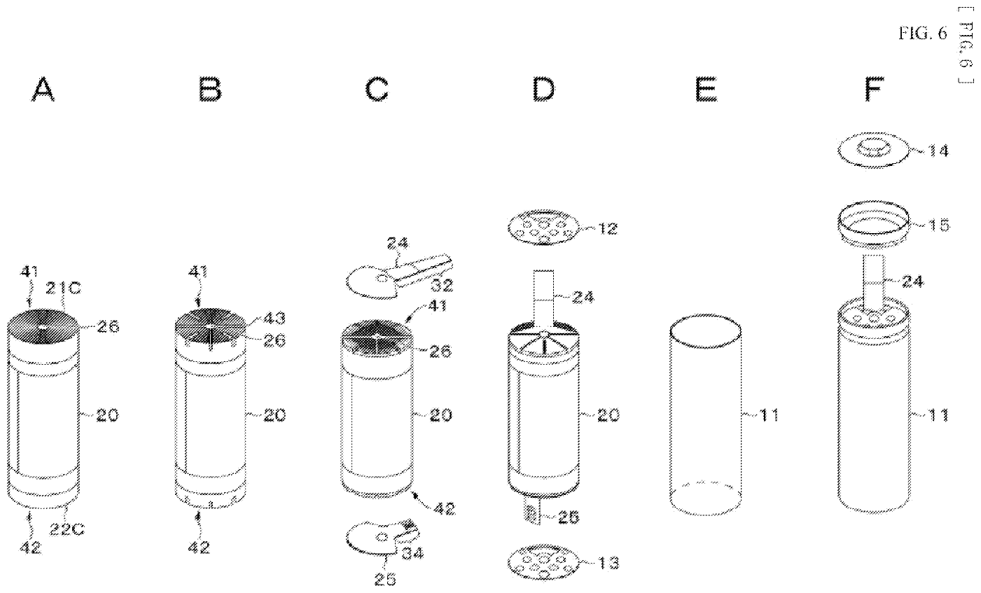

Next, a method of fabricating the lithium ion battery 1 according to an embodiment will be described with reference to FIG. 6, views A to F. First, the positive electrode active material was applied on the surface of the positive electrode foil 21A having a band shape to thereby form the positive electrode active material covered part 21B, and the negative electrode active material was applied on the surface of the negative electrode foil 22A having a band shape to thereby form the negative electrode active material covered part 22B. At this time, the positive electrode active material uncovered part 21C without the positive electrode active material applied thereon was provided on one end side in the width direction of the positive electrode foil 21A, and the negative electrode foil 22A was provided with the negative electrode active material uncovered part 22C (including the first negative electrode active material uncovered part 221A, the second negative electrode active material uncovered part 221B, and the third negative electrode active material uncovered part 221C) without the negative electrode active material applied thereon. Further, the insulating layer 22D was provided when providing the negative electrode active material covered part 22B. Thereafter, the positive electrode 21 and the negative electrode 22 were subjected to processes including a drying process. Thereafter, the positive electrode 21 and the negative electrode 22 were laid over each other with the separator 23 interposed therebetween in such a manner that the positive electrode active material uncovered part 21C and the negative electrode active material uncovered part 22C faced toward opposite directions, and they were wound in a spiral shape to allow the through hole 26 to develop on the central axis. Thus, the electrode wound body 20 as illustrated in FIG. 6, view A was fabricated.

Thereafter, grooves 43 were produced, as illustrated in FIG. 6, view B, in a portion of each of the end faces 41 and 42 by pressing an edge of a thin flat plate or the like (having a thickness of 0.5 mm, for example) perpendicularly against each of the end faces 41 and 42. By this method, the grooves 43 were produced to extend radially from the through hole 26. For example, the grooves 43 extend from an outer edge part 27 of the end face 41 to the through hole 26, or from an outer edge part 28 of the end face 42 to the through hole 26. Note that the number and arrangement of the grooves 43 illustrated in FIG. 6B are merely one example, and the illustrated example is thus non-limiting.

Thereafter, as illustrated in FIG. 6, view C, the end faces 41 and 42 were made into flat surfaces by applying equal pressures to the end faces 41 and 42 simultaneously from both electrode sides in directions substantially perpendicular to the end faces 41 and 42 and thereby bending the positive electrode active material uncovered part 21C and the negative electrode active material uncovered part 22C (in this example, the first negative electrode active material uncovered part 221A) toward the central axis of a wound structure. At this time, a load was applied using, for example, a plate surface of a flat plate or the like to cause portions of the positive electrode active material uncovered part 21C that are located at the end face 41 to overlap with each other toward the central axis and to cause portions of the first negative electrode active material uncovered part 221A that are located at the end face 42 to overlap with each other toward the central axis. Thereafter, the fan-shaped part 31 of the positive electrode current collector 24 was coupled to the end face 41 by laser welding, and the fan-shaped part 33 of the negative electrode current collector 25 was coupled to the end face 42 by laser welding.

Thereafter, as illustrated in FIG. 6, view D, the band-shaped part 32 of the positive electrode current collector 24 and the band-shaped part 34 of the negative electrode current collector 25 were bent, the insulator 12 was attached to the positive electrode current collector 24, and the insulator 13 was attached to the negative electrode current collector 25. The electrode wound body 20 having been assembled in the above-described manner was placed into the battery can 11 illustrated in FIG. 6, view E, following which the negative electrode current collector 25 was welded to the bottom of the battery can 11 using a welding rod. The electrolytic solution was injected into the battery can 11, following which the battery can 11 was sealed with the gasket 15 and the battery cover 14, as illustrated in FIG. 6, view F. The lithium ion battery 1 was fabricated as described above.

Although not illustrated, an inspection process of inspecting the fabricated lithium ion battery 1 for winding misalignment was performed. The inspection process was performed by, for example, irradiating the lithium ion battery 1 with X rays by means of an X-ray irradiator and analyzing X-ray images obtained as a result thereof. Specifically, the inspection process was performed by sequentially irradiating a positive electrode side and a negative electrode side of the lithium ion battery 1 with X rays by means of the X-ray irradiator. Based on a change in contrast of any of the X-ray images (X-ray radiographs) obtained thereby, the lithium ion battery 1 was inspected for the presence or absence of winding misalignment. The presence or absence of winding misalignment refers to the presence or absence of a state where the positive electrode active material covered part 21B exceeds a range of the negative electrode active material covered part 22B covered with the negative electrode active material, in other words, the presence or absence of a state where the positive electrode active material covered part 21B fails to be opposed to the negative electrode active material covered part 22B. The lithium ion battery 1 in which the winding misalignment was observed was treated as a defective lithium ion battery 1. Note that the positive electrode side of the lithium ion battery 1 refers to a region including the end face 41, out of the two opposite end faces of the electrode wound body 20 having a substantially cylindrical shape. The negative electrode side of the lithium ion battery 1 refers to a region including the end face 42, out of the two opposite end faces of the electrode wound body 20 having the substantially cylindrical shape.

Note that the insulators 12 and 13 may each be an insulating tape. Further, a method of coupling may be other than laser welding. The grooves 43 remain in the flat surfaces even after the positive electrode active material uncovered part 21C and the negative electrode active material uncovered part 22C are bent, and a portion of each of the flat surfaces without the grooves 43 is coupled to the positive electrode current collector 24 or the negative electrode current collector 25; however, the grooves 43 may be coupled to a portion of the positive electrode current collector 24 or a portion of the negative electrode current collector 25.

As used herein, the term “flat surface” encompasses not only a completely flat surface but also a surface having some asperities or surface roughness to the extent that it is possible to couple the positive electrode active material uncovered part 21C and the positive electrode current collector 24 to each other and to couple a predetermined region of the negative electrode active material uncovered part 22C (e.g., the first negative electrode active material uncovered part 221A) and the negative electrode current collector 25 to each other.

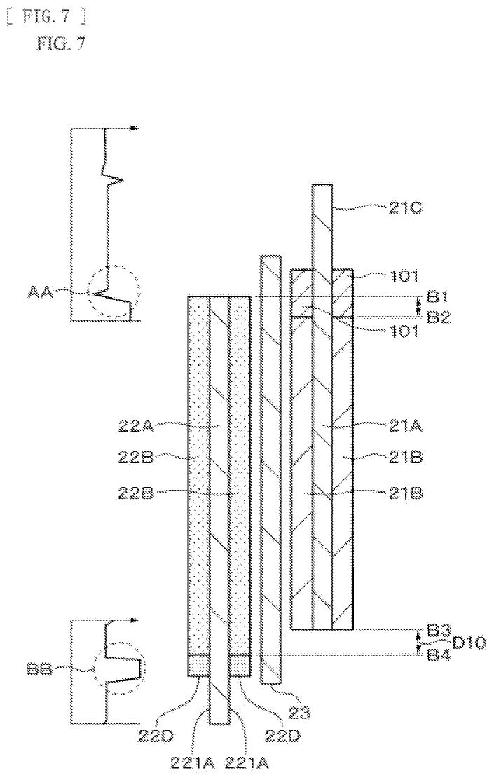

With reference to FIG. 7, a description will be given of workings of the insulating layer 22D and effects achievable by providing the insulating layer 22D. FIG. 7 is a diagram illustrating a section of the electrode wound body 20 taken along a section line XA-XA in FIG. 4. In view of convenience of description, a single layer of each of the positive electrode 21, the negative electrode 22, and the separator 23 is illustrated in FIG. 7. Further, in FIG. 7, a contrast of an X-ray image obtained when irradiating the positive electrode side of the lithium ion battery 1 with X rays is schematically illustrated on the upper left side of the sectional view, and a contrast of an X-ray image obtained when irradiating the negative electrode side of the lithium ion battery 1 with X rays is schematically illustrated on the lower left side of the sectional view.

An end of the negative electrode active material covered part 22B, i.e., an end of the negative electrode foil 22A, on the positive electrode side of the lithium ion battery 1 is denoted as a boundary B1, and an end of the positive electrode active material covered part 21B on the positive electrode side, i.e., a boundary between the positive electrode active material covered part 21B and the insulating layer 101, is denoted as a boundary B2. The boundaries B1 and B2 are each detectable based on a change in contrast of the X-ray image (a portion denoted by a reference sign AA in FIG. 7) resulting from irradiation with X-rays. The boundary B1 is also the end of the negative electrode foil 22A including copper having an X-ray shielding effect, and is therefore detectable based on a change in contrast resulting from the X-ray shielding effect of the negative electrode foil 22A. The boundary B2 is the end of the positive electrode active material covered part 21B, and is therefore detectable based on a change in contrast resulting from the X-ray shielding effect of the material included in the positive electrode active material covered part 21B, such as a lithium-containing composite oxide.

An end of the positive electrode active material covered part 21B, i.e., an end of the positive electrode foil 21A, on the negative electrode side of the lithium ion battery 1 is denoted as a boundary B3, and an end of the negative electrode active material covered part 22B on the negative electrode side, i.e., a boundary between the negative electrode active material covered part 22B and the insulating layer 22D, is denoted as a boundary B4. The boundaries B3 and B4 are each detectable based on a change in contrast of the X-ray image (a portion denoted by a reference sign BB in FIG. 7) resulting from irradiation with X-rays. The boundary B3 is the end of the positive electrode active material covered part 21B, and is therefore detectable based on a change in contrast resulting from the X-ray shielding effect of the material included in the positive electrode active material covered part 21B, such as a lithium-containing composite oxide. The boundary B4 is also an end of the insulating layer 22D having an X-ray shielding effect, and is therefore detectable based on a change in contrast resulting from the X-ray shielding effect of the insulating layer 22D. It is possible to detect the boundaries B1 to B4 based on these changes in contrast.

In order to detect the presence or absence of winding misalignment in the lithium ion battery 1 having the tabless structure, it is necessary to detect the boundaries B1 to B4 described above. According to existing techniques, it is difficult to detect the boundary B4 because no insulating layer having an X-ray shielding effect is present at the end of the negative electrode active material covered part 22B, i.e., the boundary between the negative electrode active material covered part 22B and the insulating layer 22D, and it is thus difficult to perform inspection for winding misalignment. Specifically, when a main component of the negative electrode active material covered part 22B is graphite (C), it is difficult to detect, for example, the boundary between the first negative electrode active material uncovered part 221A and the negative electrode active material covered part 22B, that is, the end of the negative electrode active material covered part 22B in an X-ray image. A reason for this is that when X rays having such an intensity as to pass through the negative electrode foil 22A including copper (Cu) as a main component are applied, the above-described boundary does not appear as a change in contrast of the X-ray image because the main component of the negative electrode active material covered part 22B, i.e., graphite, is lower in X-ray shielding effect than the negative electrode foil 22A.

As described above, it has been difficult to perform inspection for winding misalignment by X rays. However, the quality of the lithium ion battery has to be ensured. For this purpose, in order to allow the positive electrode active material covered part 21B to be reliably opposed to the negative electrode active material covered part 22B, it has been necessary to set a length of the positive electrode active material covered part 21B in the width direction to a small value. Specifically, a distance D10 (see FIGS. 4 and 7) between the end of the positive electrode active material covered part 21B and the end of the negative electrode active material covered part 22B has been set to a large value, to be on the safe side, to thereby provide a configuration of a lithium ion battery that helps to prevent the occurrence of winding misalignment as much as possible. Such a configuration has a disadvantage in that, because the length of the positive electrode active material covered part 21B in the width direction is limited to a small value, it is difficult to increase the battery capacity.

According to the present embodiment, as described above, a positional relationship between the components is clarified. This makes it possible to detect the boundaries B1 to B4, thus allowing for performing inspection for winding misalignment. Accordingly, it is possible to ensure the quality of the lithium ion battery 1 and to also improve safety. Furthermore, because the inspection for winding misalignment becomes possible, it is no longer necessary to set the length of the positive electrode active material covered part 21B in the width direction to a small value to be on the safe side. This makes it possible to set the length of the positive electrode active material covered part 21B in the width direction to a larger value than in an existing lithium ion battery. Accordingly, it is possible to increase the battery capacity of the lithium ion battery 1.

Note that in the present embodiment, the negative electrode foil 22A includes copper as the main component. Accordingly, as the insulating layer 22D, a layer including a metal (a metal element as a simple substance) that is sufficiently greater in atomic weight than copper, i.e., sufficiently greater in X-ray shielding effect than copper, or a layer including a compound of such a metal, is formed to be in contact with the end (a coating end) of the negative electrode active material covered part 22B. This makes it possible to detect the end of the negative electrode active material covered part 22B based on a change in contrast resulting from X-ray shielding.

For example, copper has an atomic weight of 63.55. Accordingly, the insulating layer 22D is formed by: mixing particles of, for example, yttrium oxide (Y₂O₃), i.e., an oxide of yttrium (Y) which is an element having an atomic weight greater than 63.55, that is, 88.91, into a coating material including polyvinylidene difluoride and NMP; applying the resulting mixture to be in contact with the end of the negative electrode active material covered part 22B; and drying the applied mixture. This makes it possible to detect the end of the negative electrode active material covered part 22B based on a contrast of the X-ray radiograph.

Note that barium sulfate (BaSO₄), which includes barium (Ba) having an atomic weight of 137.3, may be employed instead of yttrium oxide. Alternatively, a simple substance of tungsten (W) having an atomic weight of 183.8 may be employed instead of yttrium oxide. Alternatively, strontium carbonate (SrCO₃), which includes strontium (Sr) having an atomic weight of 87.62, may be employed instead of yttrium oxide.

During fabrication of the lithium ion battery 1, the negative electrode active material can sometimes peel off the negative electrode active material covered part 22B on the beginning side of winding of the electrode wound body 20, i.e., an end side in the longitudinal direction of the positive electrode or the negative electrode located in an innermost wind of the electrode wound body 20, when the edge of a thin flat plate or the like (having a thickness of 0.5 mm, for example) is pressed perpendicularly against each of the end faces 41 and 42, that is, when the process illustrated in FIG. 6, view B is performed. A possible cause of the peeling is stress generated upon pressing the thin flat plate or the like against the end face 42. The negative electrode active material having peeled off can enter the inside of the electrode wound body 20 and can thereby cause an internal short circuit. According to the present embodiment, the provision of the second negative electrode active material uncovered part 221B and the third negative electrode active material uncovered part 221C helps to prevent the peeling of the negative electrode active material, thereby helping to prevent the occurrence of the internal short circuit. Such an effect is achievable even with a configuration in which only either the second negative electrode active material uncovered part 221B or the third negative electrode active material uncovered part 221C is provided; however, it is preferable that both be provided.

On the end side of the winding of the electrode wound body 20, the negative electrode 22 may have a region of the negative electrode active material uncovered part 22C at a major surface facing away from the positive electrode active material covered part 21B. A reason for this is that even if the negative electrode active material covered part 22B is present at the major surface facing away from the positive electrode active material covered part 21B, its contribution to charging and discharging is considered to be low. The region of the negative electrode active material uncovered part 22C preferably falls within a range from 3/4 winds to 5/4 winds, both inclusive, of the electrode wound body 20. In this case, owing to the absence of the negative electrode active material covered part 22B that is low in contribution to charging and discharging, it is possible to make an initial capacity higher with respect to the same volume of the electrode wound body 20.

According to the present embodiment, in the electrode wound body 20, the positive electrode 21 and the negative electrode 22 are laid over each other and wound in such a manner that the positive electrode active material uncovered part 21C and the negative electrode active material uncovered part 22C face toward opposite directions. Thus, the positive electrode active material uncovered part 21C is localized to the end face 41, and the negative electrode active material uncovered part 22C is localized to the end face 42 of the electrode wound body 20. The positive electrode active material uncovered part 21C and the first negative electrode active material uncovered part 221A are bent to make the end faces 41 and 42 into flat surfaces. The direction of bending is from the outer edge part 27 of the end face 41 toward the through hole 26, or from the outer edge part 28 of the end face 42 toward the through hole 26. Portions of the active material uncovered part that are located in adjacent winds in a wound state are bent and overlap with each other. By making the end face 41 into a flat surface, it is possible to achieve better contact between the positive electrode active material uncovered part 21C and the positive electrode current collector 24, and to achieve better contact between the first negative electrode active material uncovered part 221A and the negative electrode current collector 25. Further, the configuration in which the end faces 41 and 42 are made into flat surfaces by bending makes it possible for the lithium ion battery 1 to achieve reduced resistance.

It may seem to be possible to make the end faces 41 and 42 into flat surfaces by bending the positive electrode active material uncovered part 21C and the first negative electrode active material uncovered part 221A; however, without any processing in advance of bending, creases or voids (gaps or spaces) can develop in the end faces 41 and 42 upon bending, thus making it difficult for the end faces 41 and 42 to be flat surfaces. Here, “creases” and “voids” are unevenness that can develop in the positive electrode active material uncovered part 21C and the first negative electrode active material uncovered part 221A having been bent, resulting in non-flat portions of the end faces 41 and 42. In the present embodiment, the grooves 43 are formed in advance in radial directions from the through hole 26 on each of the end face 41 side and the end face 42 side. The presence of the grooves 43 helps to prevent the creases and voids from developing, and thereby helps to achieve increased flatness of the end faces 41 and 42. Note that although either the positive electrode active material uncovered part 21C or the first negative electrode active material uncovered part 221A may be bent, it is preferable that both be bent.

In the following, the present disclosure will be described in further detail including with reference to an Example and a comparative example in which the lithium ion batteries 1 fabricated in the above-described manner were used to evaluate their discharge capacities. Note that the present disclosure is not limited thereto.

For each of Example and the comparative example described below, a battery size was set to 21700 (21 mm in diameter and 70 mm in height), a length of the positive electrode active material covered part 21B in the longitudinal direction was set to 1320 mm, a length of the negative electrode active material covered part 22B in the longitudinal direction was set to 1400 mm, a length of the negative electrode active material covered part 22B in the width direction was set to 63 mm, and a length of the separator 23 in the width direction was set to 64 mm. The separator 23 was placed to cover all of regions of the positive electrode active material covered part 21B and the negative electrode active material covered part 22B. The number of the grooves 43 was set to eight, and the eight grooves were arranged at substantially equal angular intervals.

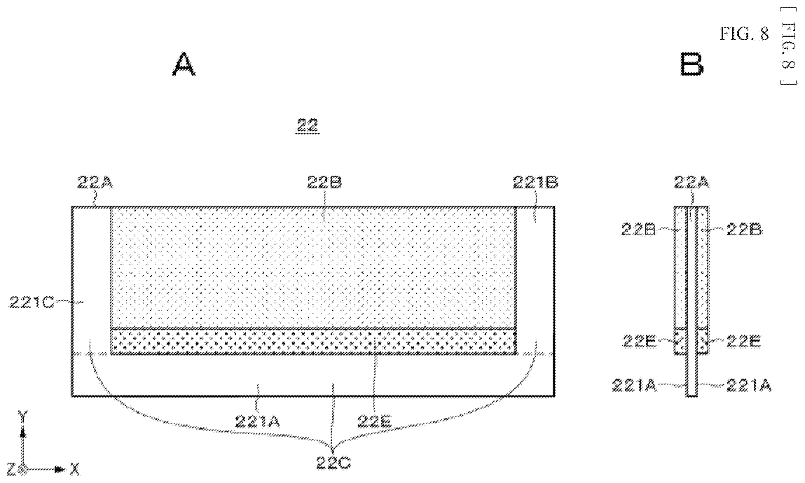

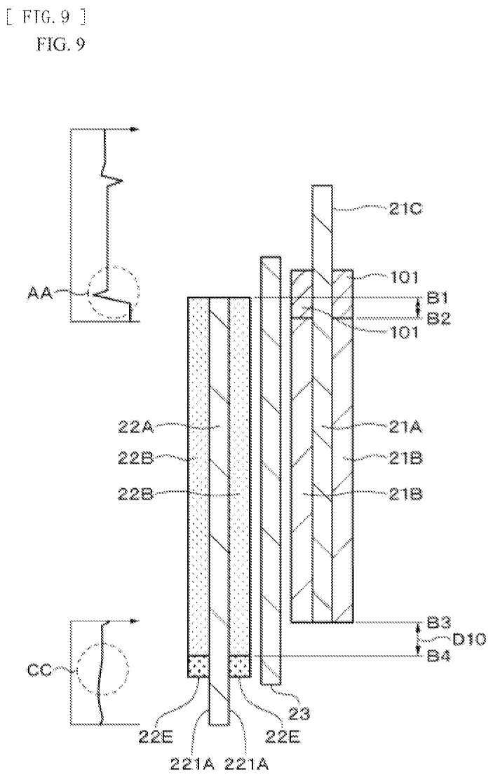

FIG. 3 is a diagram corresponding to Example 1. FIGS. 8 and 9 are diagrams each corresponding to Comparative example 1.

### Example 1

The lithium ion battery 1 was fabricated through the above-described process. In fabricating the lithium ion battery 1, as illustrated in FIG. 3, the negative electrode active material covered part 22B and the negative electrode active material uncovered part 22C were provided at each of both surfaces of the negative electrode foil 22A, and the negative electrode foil 22A was cut at a position of the negative electrode active material uncovered part 22C to thereby provide the first negative electrode active material uncovered part 221A, the second negative electrode active material uncovered part 221B, and the third negative electrode active material uncovered part 221C. Further, the insulating layer 22D was provided between the negative electrode active material covered part 22B and the first negative electrode active material uncovered part 221A. A length of the insulating layer 22D in the width direction was set to 3 (mm). The insulating layer 22D was formed by applying a coating material including PVDF, particles of barium sulfate, and NMP, and drying the coating film.

### Comparative Example 1

As illustrated in FIG. 8A, the negative electrode active material covered part 22B and the negative electrode active material uncovered part 22C were provided at each of both surfaces of the negative electrode foil 22A, and the negative electrode foil 22A was cut at the position of the negative electrode active material uncovered part 22C to thereby provide the first negative electrode active material uncovered part 221A, the second negative electrode active material uncovered part 221B, and the third negative electrode active material uncovered part 221C. Further, an insulating layer 22E was provided between the negative electrode active material covered part 22B and the first negative electrode active material uncovered part 221A. A length of the insulating layer 22E in the width direction was set to 3 (mm). The insulating layer 22E was formed using a coating material including neither of a metal and a metal compound each having an X-ray shielding effect. The lithium ion battery 1 was fabricated in a manner similar to that in Example 1 except for the above differences.

The discharge capacity was measured in the following manner. The lithium ion battery 1 was subjected to constant voltage and constant current charging at 2000 mA in an atmosphere at 23° C.±2° C. for 3.5 hours, with a final voltage set to 4.20 V. Thereafter, discharging was performed in the same atmosphere at 0.2 ItA (800 mA), with a final voltage set to 2.0 V. The resulting capacity value was determined as the discharge capacity. The results are given in Table 1 below.

TABLE 1

| | | Length of active material | | Length of active material | | |
|---|---|---|---|---|---|---|
| | | covered part in | | covered part in | | |
| | | longitudinal direction [mm] | | width direction [mm] | | Discharge |
| | Corresponding | Positive | Negative | Positive | Negative | capacity |
| | figure | electrode | electrode | electrode | electrode | [mAh] |
| Example 1 | FIG. 3 | 1320 | 1400 | 62 | 63 | 4304 (about |
| | | | | | | 3% increase) |
| Comparative | FIG. 8 and | 1320 | 1400 | 60 | 63 | 4166 |
| example 1 | FIG. 9 | | | | | |

In Example 1, it was possible to perform inspection for winding misalignment, and this made it possible to reduce the distance D10 between the end of the positive electrode active material covered part 21B and the end of the negative electrode active material covered part 22B. In contrast, in Comparative example 1, because the insulating layer 22E included neither of a metal and a metal compound each having an X-ray shielding effect, no change in contrast appeared in the X-ray image as illustrated in a portion denoted by a reference sign CC in FIG. 9, and thus the boundary B4 was not detectable. Accordingly, it was not possible to perform inspection for winding misalignment, which made it necessary to set the distance D10 between the end of the positive electrode active material covered part 21B and the end of the negative electrode active material covered part 22B to a large value to be on the safe side. As a result, in Example 1, it was possible to make the length of the positive electrode active material covered part 21B in the width direction larger by 2 mm than that in Comparative example 1. The increase in the length of the positive electrode active material covered part 21B in the width direction resulted in a discharge capacity of 4304 mAh in Example 1, allowing for an increase in discharge capacity by about 3% relative to the discharge capacity in Comparative example 1, i.e., 4166 mAh.

Based upon the above, the configuration presented in Example 1 is considered to be a preferable configuration of the lithium ion battery 1.

Although the present disclosure has been described herein according to an embodiment, the contents of the present disclosure are not limited thereto, and various modifications may be made according to an embodiment.

The present technology is also applicable to a battery having a tabless structure in which neither the positive electrode active material uncovered part 21C nor the first negative electrode active material uncovered part 221A is bent. Although a configuration having the second negative electrode active material uncovered part 221B and the third negative electrode active material uncovered part 221C is preferable, the present technology is also applicable to a lithium ion battery including neither of the second and third negative electrode active material uncovered parts 221B and 221C according to an embodiment.

Although the number of the grooves 43 is eight in Example and the comparative example, any other number may be chosen. Although the battery size chosen is 21700 (21 mm in diameter and 70 mm in height), the battery size may be 18650 (18 mm in diameter and 65 mm in height) or any other size.

The fan-shaped parts 31 and 33 may each have a shape other than the fan shape.

The present technology is applicable to a lithium ion battery or any suitable battery other than a lithium ion battery, and to any suitable battery having a cylindrical shape and any suitable battery having a shape other than a cylindrical shape, such as a laminated battery, a prismatic battery, a coin-type battery, or a button-type battery. In such a case, the shape of the “end face of the electrode wound body” is not limited to a circular shape, and may be any of other shapes including, without limitation, an elliptical shape and an elongated shape.

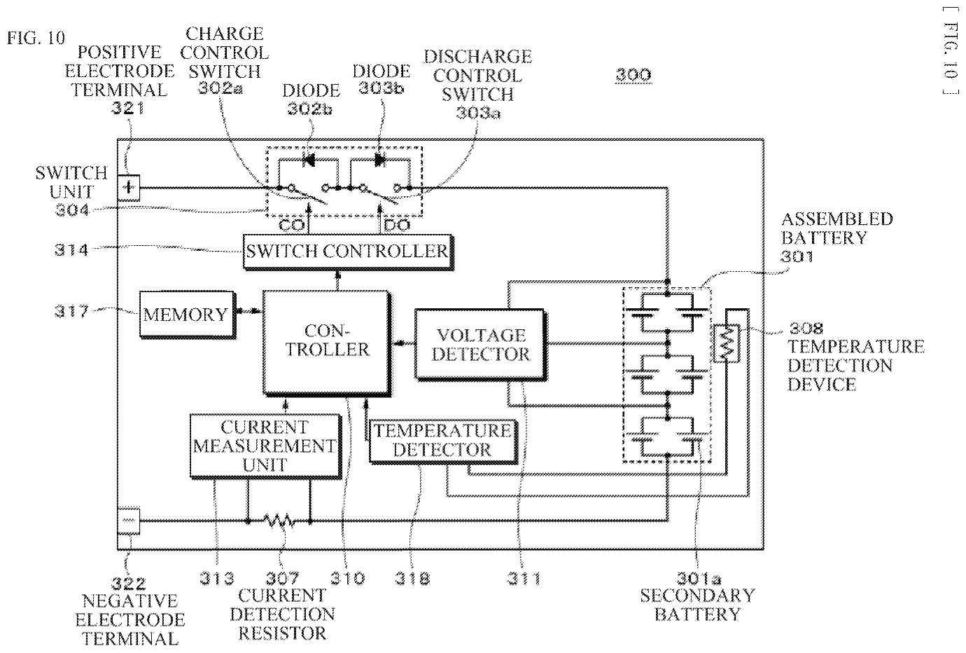

FIG. 10 is a block diagram illustrating a circuit configuration example where the secondary battery according to an embodiment is applied to a battery pack 300. The battery pack 300 includes an assembled battery 301, a switch unit 304, a current detection resistor 307, a temperature detection device 308, and a controller 310. The switch unit 304 includes a charge control switch 302a and a discharge control switch 303a. The controller 310 controls each device. Further, the controller 310 is able to perform charge and discharge control upon abnormal heat generation, and to perform calculation and correction of a remaining capacity of the battery pack 300. The battery pack 300 includes a positive electrode terminal 321 and a negative electrode terminal 322 that are couplable to a charger or electronic equipment for charging and discharging.

The assembled battery 301 includes multiple secondary batteries 301a coupled in series or in parallel. FIG. 10 illustrates an example case in which six secondary batteries 301a are coupled in a two parallel coupling and three series coupling (2P3S) configuration. The secondary battery according to an embodiment is applicable to the secondary battery 301a.

A temperature detector 318 is coupled to the temperature detection device 308 (for example, a thermistor). The temperature detector 318 measures a temperature of the assembled battery 301 or the battery pack 300, and supplies the measured temperature to the controller 310. A voltage detector 311 measures a voltage of the assembled battery 301 and a voltage of each of the secondary batteries 301a included therein, performs A/D conversion on the measured voltages, and supplies the converted voltages to the controller 310. A current measurement unit 313 measures currents using the current detection resistor 307, and supplies the measured currents to the controller 310.

A switch controller 314 controls the charge control switch 302a and the discharge control switch 303a of the switch unit 304 based on the voltages and the currents respectively supplied from the voltage detector 311 and the current measurement unit 313. When the voltage of any of the secondary batteries 301a becomes higher than or equal to an overcharge detection voltage or becomes lower than or equal to an overdischarge detection voltage, the switch controller 314 transmits a turn-off control signal to the switch unit 304 to thereby prevent overcharging or overdischarging. The overcharge detection voltage is, for example, 4.20 V±0.05 V. The overdischarge detection voltage is, for example, 2.4 V±0.1 V.

After the charge control switch 302a or the discharge control switch 303a is turned off, charging or discharging is enabled only through a diode 302b or a diode 303b. Semiconductor switches such as MOSFETs are employable as these charge and discharge control switches. Note that although the switch unit 304 is provided on a positive side in FIG. 10, the switch unit 304 may be provided on a negative side.

A memory 317 includes a RAM and a ROM. Numerical values including, for example, battery characteristic values, a full charge capacity, and a remaining capacity calculated by the controller 310 are stored and rewritten therein.

The secondary battery according to an embodiment is mountable on equipment such as electronic equipment, electric transport equipment, or a power storage apparatus, and is usable to supply electric power.

Examples of the electronic equipment include laptop personal computers, smartphones, tablet terminals, personal digital assistants (PDAs) (mobile information terminals), mobile phones, wearable terminals, digital still cameras, electronic books, music players, game machines, hearing aids, electric tools, televisions, lighting equipment, toys, medical equipment, and robots. In addition, for example, electric transport equipment, power storage apparatuses, and electric unmanned aerial vehicles, which will be described later, may also be included in the electronic equipment in a broad sense.

Examples of the electric transport equipment include electric automobiles (including hybrid electric automobiles), electric motorcycles, electric-assisted bicycles, electric buses, electric carts, automated guided vehicles (AGVs), and railway vehicles. Examples of the electric transport equipment further include electric passenger aircrafts and electric unmanned aerial vehicles for transportation. The secondary battery according to an embodiment is used not only as a driving power source for the foregoing electric transport equipment but also as, for example, an auxiliary power source or an energy-regenerative power source therefor.

Examples of the power storage apparatuses include a power storage module for commercial or household use, and a power storage power source for architectural structures including residential houses, buildings, and offices, or for power generation facilities.

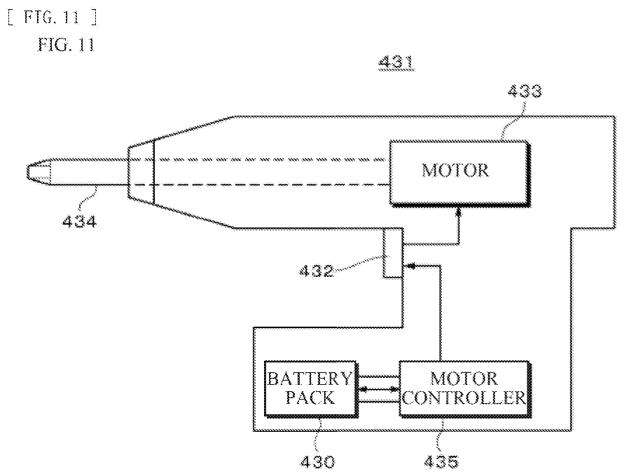

As an example of the electric tools to which the present technology is applicable, an electric screwdriver will be schematically described with reference to FIG. 11. An electric screwdriver 431 includes a motor 433 and a trigger switch 432. The motor 433 transmits rotational power to a shaft 434. The trigger switch 432 is operated by a user. A battery pack 430 and a motor controller 435 are contained in a lower housing of a handle of the electric screwdriver 431. The battery pack 430 is built in or detachably attached to the electric screwdriver 431. The secondary battery of an embodiment is applicable to a battery included in the battery pack 430.

The battery pack 430 and the motor controller 435 may include respective microcomputers (not illustrated) communicable with each other to transmit and receive charge and discharge data on the battery pack 430. The motor controller 435 controls operation of the motor 433, and is able to cut off power supply to the motor 433 under abnormal conditions such as overdischarging.

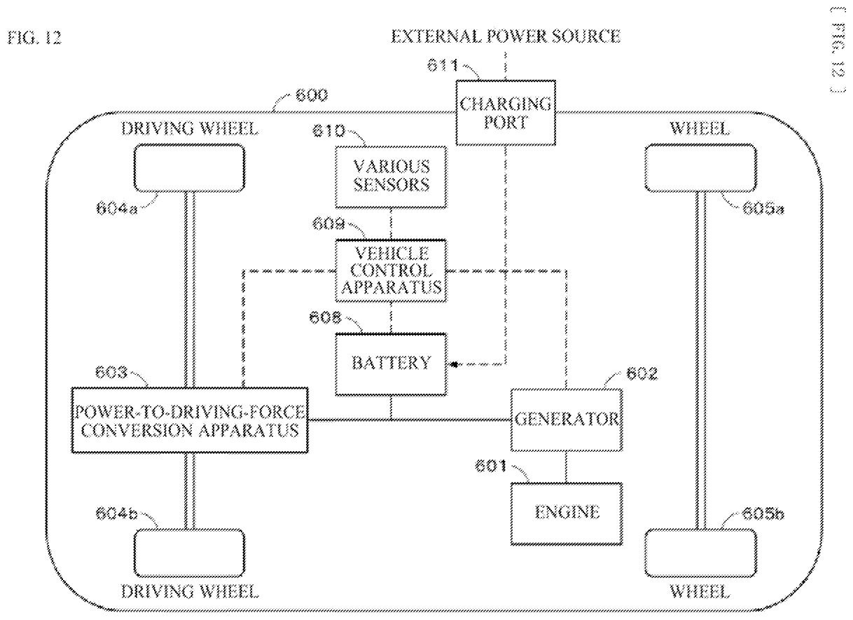

As an example of application of the present technology to a power storage system for electric vehicles, FIG. 12 schematically illustrates a configuration example of a hybrid vehicle (HV) that employs a series hybrid system. The series hybrid system relates to a vehicle that travels with an electric-power-to-driving-force conversion apparatus, using electric power generated by a generator that uses an engine as a power source, or using electric power temporarily stored in a battery.

A hybrid vehicle 600 is equipped with an engine 601, a generator 602, an electric-power-to-driving-force conversion apparatus (a direct-current motor or an alternating-current motor; hereinafter, simply “motor 603”), a driving wheel 604a, a driving wheel 604b, a wheel 605a, a wheel 605b, a battery 608, a vehicle control apparatus 609, various sensors 610, and a charging port 611. The secondary battery according to an embodiment, or a power storage module equipped with a plurality of secondary batteries according to an embodiment is applicable to the battery 608.

The motor 603 operates under the electric power of the battery 608, and a rotational force of the motor 603 is transmitted to the driving wheels 604a and 604b. Electric power generated by the generator 602 using a rotational force generated by the engine 601 is storable in the battery 608. The various sensors 610 control an engine speed via the vehicle control apparatus 609, and control an opening angle of an unillustrated throttle valve.

When the hybrid vehicle 600 is decelerated by an unillustrated brake mechanism, a resistance force at the time of deceleration is applied to the motor 603 as a rotational force, and regenerative electric power generated from the rotational force is stored in the battery 608. In addition, the battery 608 is chargeable by being coupled to an external power source via the charging port 611 of the hybrid vehicle 600. Such an HV vehicle is referred to as a plug-in hybrid vehicle (PHV or PHEV).

Note that the secondary battery according to an embodiment may be applied to a small-sized primary battery and used as a power source of an air pressure sensor system (a tire pressure monitoring system: TPMS) built in the wheels 604 and 605.

Although the series hybrid vehicle has been described as an example, the present technology is applicable also to a hybrid vehicle of a parallel system in which an engine and a motor are used in combination, or of a combination of the series system and the parallel system. Furthermore, the present technology is applicable to an electric vehicle (EV or BEV) and a fuel cell vehicle (FCV) that travel by means of only a driving motor without using an engine.

### REFERENCE SIGNS LIST

1: lithium ion battery
12: insulator
21: positive electrode
21A: positive electrode foil
21B: positive electrode active material layer
21C: positive electrode active material uncovered part
22: negative electrode
22A: negative electrode foil
22B: negative electrode active material layer
22C: negative electrode active material uncovered part
23: separator
22D: insulating layer
24: positive electrode current collector
25: negative electrode current collector
26: through hole
41, 42: end face
43: groove
221A: first negative electrode active material uncovered part
221B: second negative electrode active material uncovered part
221C: third negative electrode active material uncovered part

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a positive electrode having a band shape and a negative electrode having a band shape, the positive electrode and the negative electrode being stacked with a separator interposed therebetween;
a positive electrode current collector;
a negative electrode current collector; and
a battery can containing the electrode wound body, the positive electrode current collector, and the negative electrode current collector, wherein
the positive electrode includes, on a positive electrode foil having a band shape, a positive electrode active material covered part covered with a positive electrode active material layer, and a positive electrode active material uncovered part,
the negative electrode includes, on a negative electrode foil having a band shape, a negative electrode active material covered part covered with a negative electrode active material layer, a negative electrode active material uncovered part extending at least in a longitudinal direction of the negative electrode foil, and an insulating layer provided between the negative electrode active material covered part and the negative electrode active material uncovered part,
the positive electrode active material uncovered part is coupled to the positive electrode current collector at one of end parts of the electrode wound body,
the negative electrode active material uncovered part is coupled to the negative electrode current collector at another of the end parts of the electrode wound body, and
the insulating layer includes a metal or metal compound having an X-ray shielding effect higher than a predetermined X-ray shielding effect.

2. The secondary battery according to claim 1, wherein the insulating layer includes a metal having an X-ray shielding effect higher than an X-ray shielding effect of a metal included in the negative electrode foil, or includes a metal compound including a metal having an X-ray shielding effect higher than the X-ray shielding effect of the metal included in the negative electrode foil.

3. The secondary battery according to claim 2, wherein
the metal comprises one or more selected from the group consisting of tungsten, iridium, platinum, and gold, and
the metal compound comprises one or more selected from the group consisting of a metal oxide, a metal sulfate compound, and a metal carbonate compound.

4. The secondary battery according to claim 3, wherein
the metal oxide comprises one or more selected from the group consisting of yttrium oxide, hafnium oxide, tantalum pentoxide, and tungsten oxide,
the metal sulfate compound comprises one or more selected from the group consisting of barium sulfate and strontium sulfate, and
the metal carbonate compound comprises strontium carbonate.

5. The secondary battery according to claim 2, wherein the metal included in the negative electrode foil comprises copper.

6. The secondary battery according to claim 1, wherein the electrode wound body has one or more flat surfaces, in which the positive electrode active material uncovered part, the negative electrode active material uncovered part, or both are bent toward a central axis of the wound structure to form the one or more flat surfaces, and a groove provided in each of the one or more flat surfaces.

7. The secondary battery according to claim 1, wherein the negative electrode further includes a negative electrode active material uncovered part at an end part in the longitudinal direction on each of a beginning side of winding and an end side of the winding.

8. Electronic equipment comprising the secondary battery according to claim 1.

9. An electric tool comprising the secondary battery according to claim 1.
